(19) United States
(12) Patent Application Publication
(10) Pub. No.: US 2004/0117691 A1
(43) Pub. Date: Jun. 17, 2004

(54) METHOD AND RELATED DEVICE FOR RELIABLY RECEIVING A DIGITAL SIGNAL

(76) Inventor: George Fang, Irvine, CA (US)

Correspondence Address: NAIPO (NORTH AMERICA INTERNATIONAL PATENT OFFICE), P.O. BOX 506, MERRIFIELD, VA, 22116, US

(21) Appl. No.: 10/248,049

(22) Filed: Dec. 13, 2002

(51) Int. Cl. H04K 1/00; H04B 1/69; H04B 1/707; H04B 1/713; H04B 15/00; H04L 27/30; G06K 5/04

(52) U.S. Cl. 714/699

(57) ABSTRACT

A method for receiving a digital signal and compensating for signal skew and circuit unbalance oversamples a data segment of the digital signal, detects transitions in the oversampled data, tallies transitions for phases of the oversampled data, selects as an output phase a next phase that is offset from a phase that has the most transitions being more than a predetermined number of transitions for a predetermined number of data segments of the digital signal, and outputs bits of the oversampled data corresponding to the output phase selected. A circuit for performing the method includes a transition counter and corresponding decision logic.

### BACKGROUND OF INVENTION

1. Field of the Invention

The present invention relates to serial data transmission, and more specifically, to a method and related circuit for receiving a digital signal.

2. Description of the Prior Art

Analog display devices, such as a declining majority of CRT and LCD monitors, use signals transmitted in analog form. Information sent is typically encoded as a voltage or current signal, and consequently must be decoded before being displayed.

Due to properties of analog signals, they are inherently susceptible to signal degradation, and the quality of images displayed by analog display devices is easily compromised. As resolutions of display devices are constantly increasing, maintaining quality and integrity of received analog signals is becoming unmanageable. Moreover, problems associated with preserving signal quality with higher frequency and higher amplitude signals are becoming more difficult to control.

To address the above-mentioned issues digital signal transmission methods have been developed. One such method is described in U.S. Pat. No. 5,905,769, which is incorporated in its entirety herein by reference. In these methods, an input signal is first oversampled by an analog phase-locked loop (PLL) controlled sampling circuit. Then, a digital phase adjusting circuit is used to compensate for phase jitter between a sampling clock and input data, phase jitter or skew being one of the main sources of error.

Consider FIG. 1a showing a digital signal 10 transmitting a “101” according to a typical digital signal transmission method. At clock pulses 12 the signal 10 is 3-times oversampled generating oversampled data 14a. The oversampled data 14a perfectly reflects the data of the signal 10. Circuit logic, such as a phase detector, is applied to select a phase (the 1st, 2nd, or 3rd oversampled bit of each original bit) of oversampled data 14a for output. In this case, because of the exactness of the sampling, selecting any phase the oversampled data 14a results in a correct sample of the original data. However, it is well known that digital circuits can be unbalanced, tending to incorrectly go high or low depending on the circuitry itself and on the nature of the signal 10. Referring to FIG. 1b, consider oversampled data 14b generated by a circuit that tends to read low when the signal 10 is skewed, the signal 10 being skewed by transmission with respect to recovered clock pulses 12b. At clock pulses 12b the signal 10 is oversampled and erroneous samples 16 result because of the unbalanced circuit. These incorrect samples can lead to output errors if they are not adequately taken into account.

The prior art methods and circuits for receiving digital signals and providing skew compensation for these signals do not sufficiently address the above-mentioned problem of circuit unbalance. Data errors caused by this problem result in poor performance of current digital signal transmission schemes.

### SUMMARY OF INVENTION

It is therefore a primary objective of the claimed invention to provide a method and related circuit for receiving a digital signal to solve the aforementioned problems of circuit unbalance and signal skew.

Briefly summarized, the claimed invention includes digitally oversampling a data segment of a digital signal, detecting transitions in the oversampled data, tallying transitions for phases of the oversampled data, selecting an output phase from a phase that has the most number of transitions and has more than a predetermined number of transitions for a predetermined number of data segments of the digital signal, and outputting bits of the oversampled data corresponding to the phase selected as the output phase. The oversampled data segment has a number of bits equal to the number of bits of the data segment multiplied by an oversampling factor. Each bit of the oversampled data corresponds to a phase being equal to a sampling order of the bit, a number of phases being equal to the oversampling factor.

According to the claimed invention, a circuit for receiving a digital signal includes a phase-locked loop, a digital oversampler, a skew compensator, and a decoder. The skew compensator has a transition counter for detecting digital transitions of oversampled data of a digital signal and tallying each transition according to phase, a decision logic for selecting a phase as the output phase based on the tallied transitions of each phase, and a phase selector for selecting and outputting to the decoder bits of the oversampled data corresponding to the output phase.

It is an advantage of the claimed invention that detecting and tallying transitions for phases and selecting an output phase based on the tallied transitions reduces detrimental effects of circuit unbalance.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1a is a signal diagram of an unskewed digital signal.

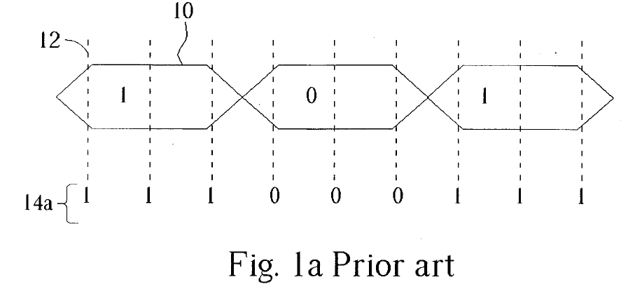

FIG. 1b is a signal diagram of a skewed digital signal as received by an unbalanced circuit according to the prior art.

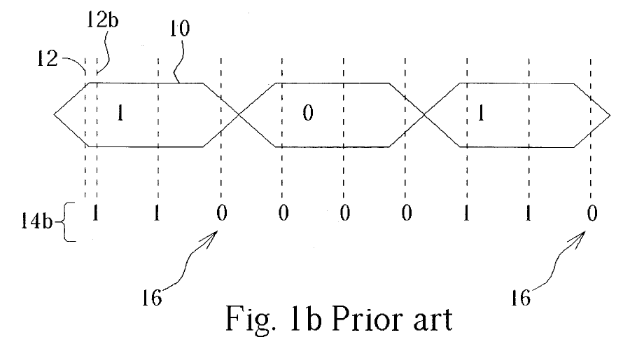

FIG. 2 is a block diagram of a circuit for receiving a digital signal according to the present invention.

FIG. 3 is a block diagram of the skew compensator of FIG. 2.

FIG. 4 is a schematic diagram of an example of the present invention method.

### DETAILED DESCRIPTION

The preferred embodiment of the present invention method and circuit will be described in the context of a circuit receiving a digital signal in 10-bit segments. While this is typical for digital video signaling, it by no means limits the present invention.

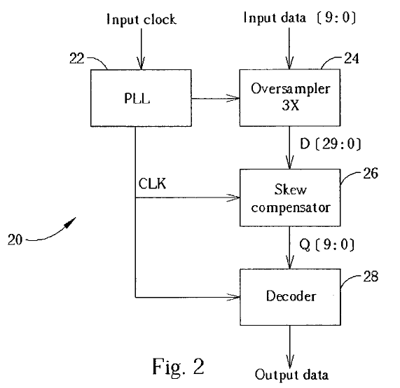

Please refer to FIG. 2 showing a circuit 20 for receiving a digital signal. The circuit 20 comprises a phase-locked loop (PLL) 22 for outputting a plurality of offset clocks to an oversampler 24, and a single clock CLK to a skew compensator 26 and a decoder 28. In the preferred embodiment the oversampler 24 performs 3-times oversampling on a 10-bit segment of an input digital video signal and outputs 30 bits of oversampled data D[29:0] to the skew compensator 26. After performing the method of the present invention, the skew compensator 26 outputs a 10-bit data segment Q[9:0] to the decoder 28. The 10-bit data segment Q[9:0] directly corresponds to the 10-bit input data and is compensated for skew and circuit unbalance. The decoder 28 decodes the data Q[9:0] and outputs data to a device such as a digital monitor.

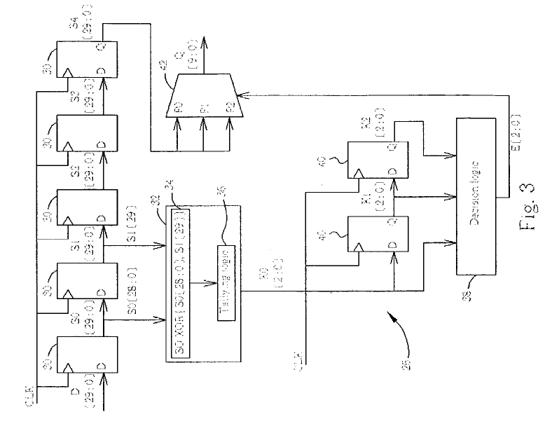

The skew compensator 26 is shown in detail in the block diagram of FIG. 3. The skew compensator includes a shift register comprising a series of 30-bit latches 30 that accepts the oversampled data segment D[29:0]. As a new segment of oversampled data is sampled, the data D[29:0] is shifted through the latches 30 as synchronized by the clock CLK. The oversampled data being shifted through the latches 30 is indicated by S0[29:0] to S4[29:0]. That is, the most recently oversampled data is S0[29:0] and the next most recent data is S1[29:0]. A transition counter 32 takes output from the latches 30 that is a 31-bit consecutive series of oversampled data being S0[29:0] and S1[29] (31-bits are required by logic of the transition counter 32). The transition counter 32 determines which phase of the 30-bit oversampled data S0[29:0] has the most transitions and outputs a result K0[2:0] to decision logic 38. Result K0[2:0] is also input into a shift register comprising 3-bit latches 40 which outputs results K1[2:0] and K2[2:0] to the decision logic 38. The decision logic 38 compares the results K0[2:0], K1[2:0], and K2[2:0] and outputs a setting state E[2:0] that controls a setting end of a multiplexer 42 to select a corresponding phase of the data S4[29:0] to output as the 10-bit output data Q[9:0].

The transition counter 32 comprises transition detection logic 34 and tallying logic 36. The transition detection logic 34 XORs adjacent bits of the oversampled data S0[29:0], which requires the additional bit S1[29] to properly complete, to generate a 30-bit output comprising a “1” where a logical transition (“1” to “0” or “0” to “1”) in the oversampled data S0[29:0] has occurred. This 30-bit output is sent to the tallying logic 36 which counts the transitions in each phase of the oversampled data S0[29:0] and outputs the 3-bit output K0[2:0]. Of the 3 phases of oversampled data S0[29:0], phase two comprises the 29th, 26th . . . 5th, and 2nd bits. Similarly phase one comprises the 28th, 25th . . . 4th, and 1st bits, and phase zero comprises the 27th, 24th . . . 3rd, and 0th bits. How the phases are defined is a matter of design choice provided that groups comprising every third bit of the oversampled data are defined as having the same phase. It should be noted that the number of phases is equal to the oversampling factor. Please refer to Table 1 for a numerical example.

TABLE 1

| | Bit | | | | | | | | | | | | | | | | | | | |
|---|---|---|---|---|---|---|---|---|---|---|---|---|---|---|---|---|---|---|---|---|
| | 29 | 28 | 27 | 26 | 25 | 24 | 23 | 22 | 21 | . . . | 8 | 7 | 6 | 5 | 4 | 3 | 2 | 1 | 0 | 29 |
| Phase | 2 | 1 | 0 | 2 | 1 | 0 | 2 | 1 | 0 | . . . | 2 | 1 | 0 | 2 | 1 | 0 | 2 | 1 | 0 | 2 |
| S0/S1 Data | 0 | 0 | 0 | 1 | 1 | 1 | 0 | 0 | 0 | | 1 | 1 | 1 | 1 | 1 | 0 | 0 | 0 | 0 | 1 |
| Transition | 0 | 0 | 1 | 0 | 0 | 1 | 0 | 0 | 1 | | 0 | 0 | 0 | 0 | 1 | 0 | 0 | 0 | 1 | — |

Note that in Table 1 the first 30 bits (29-0) are S0[29:0] and the final bit (29) is S1 [29]. Assuming S0 data from bits 20 to 9 are contiguous “1”s, it can be seen from Table 1 that phase zero has 4 transitions, phase one has 1 transition, and two has none. In the preferred embodiment, the tallying logic 36 is configured so that the 3-bit output K0[2:0] has a “1” having a position indicating the phase with the most number of transitions greater than 3. Thus, for the example data of Table 1, the output K0[2:0] of the tallying logic 36 will be (0,0,1) indicating that phase zero has the most transitions being more than 3. Had the number of transitions in phases two, one, and zero been 5, 1, and 2 respectively, the output K0[2:0] would have been (1,0,0). If two or more phases both have the same number of transitions being the most transitions and being greater than 3, K0[2:0] is set accordingly, e.g. (1,1,0).

The tallying logic 36 outputs K0[2:0] to the decision logic 38 and the first latch 40 of the 3-bit shift register as shown in FIG. 3. The 30-bit shift register formed of the latches 30 in conjunction with the 3-bit shift register formed by the latches 40 acts to delay the output of the oversampled data so as to match the data input to the multiplexer 42 with the output of the decision logic 38. The latches 40 provide the decision logic 38 with inputs K0[2:0], K1[2:0], and K2[2:0] corresponding to three sets of 30-bit oversampled data. The decision logic is configured so bits of the K0[2:0], K1 [2:0], and K2[2:0] inputs representing each phase of the oversampled data are logically ANDed. That is, the K0[2] bit, the K1[2] bit, and the K2[2] bit representing phase two are ANDed, with an identical AND operating being performed for phases one and zero. Based on this AND function, a given phase is the transition phase only if for three segments of oversampled data the number of transitions has been the most of the three phases and has been more than three. In the preferred embodiment, the decision logic 38 selects as the output phase a phase that is immediately offset from and after the phase transition phase (i.e. the next phase). The decision logic 38 is further configured to favor a previously selected phase in the case of two or more phases having the same number of the most number of transitions and the transition number being equal to or larger than 4, selecting a phase according to a predetermined rule such as a phase having a lower index number (i.e. phase zero is favored over phase one) if neither phase is the previous phase. Additionally, the previous phase is selected in no phases have four or more transitions (e.g. K0[2:0]=(0,0,0)). Based on this logic, the decision logic 38 outputs a 3-bit setting output E [2:0] to the multiplexer 42. Table 2 shows states of the setting output E[2:0] when the previous state is E[2:0]=(0,1,0) for phase one.

TABLE 2

| K0 AND K1 AND K2 | Phase Selected | [symbol] |
|---|---|---|
| (0, 0, 0) | Previous | (0, 1, 0) |
| (0, 0, 1) | One | (0, 1, 0) |
| (0, 1, 0) | Two | (1, 0, 0) |
| (1, 0, 0) | Zero | (0, 0, 1) |
| (0, 1, 1) | Previous | (0, 1, 0) |
| (1, 0, 1) | Previous | (0, 1, 0) |
| (1, 1, 0) | Predetermined rule | (1, 0, 0) |
| (1, 1, 1) | Previous | (0, 1, 0) |

After receiving the input E[2:0], the multiplexer 42 selects bits of the 30-bit oversampled data corresponding to the selected phase and outputs 10-bit data Q [9:0].

In another embodiment of the present invention, the tallying logic 36 selects a phase offset from a phase having the most number of transitions, without the limitation that the number of transitions be 4 or more. This limitation of 4 transitions minimum simply works well with 30 bits of oversampled data for digital video signals, and in practical application can be set to any desired value including 1.

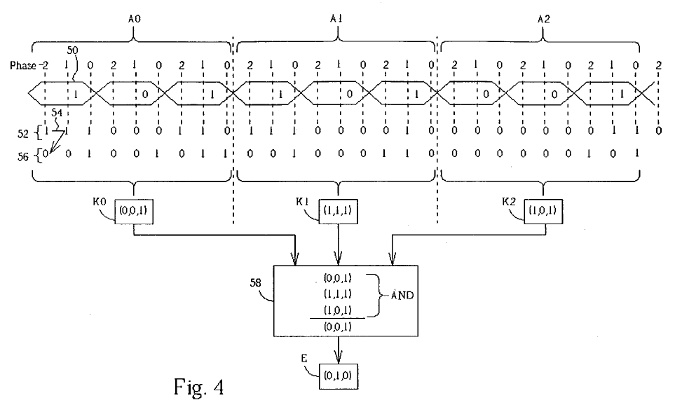

Please refer to FIG. 4 showing an example of the present invention method according to the above description. For simplicity of explanation, a digital signal 50 is 3-times oversampled in 3-bit segments A0, A1, and A2 rather than the 10-bit segments as previously described, and the 4 transition minimum rule is ignored. This means that a circuit designed in accordance with FIG. 4 would require the latches 30 of FIG. 3 to be 9-bit rather than 30-bit. The adjacent bits of the oversampled data 52 are XORed as illustrated by the arrow 54 resulting in a series of transition bits 56 (where a “1” indicates a transition in the oversampled data 52). The oversampling suffers from circuit unbalance favoring a low state and the digital signal 50 may or may not be skewed. The transition bits 56 are tallied and resultants K0, K1, and K2 are determined based on in which phases of the oversampled data 52 the most transitions occur. The resultants K0, K1, and K2 are ANDed and further logic is performed according to the predetermined rule and the previous output state if necessary by decision logic 58 (being similar to decision logic 38 in FIG. 3), and finally, a phase selecting output E is determined. The decision logic 58 is configured to output the phase directly after a phase having the most transitions. In the example of FIG. 4, all 3 resultants K0, K1, and K2 indicate phase zero, with resultant K1 additionally indicating phases one and two and resultant K2 additionally indicating phase two. As a result, phase one is selected as the output phase.

Generally, the method of the present invention can be performed by executing the following steps (with preferred embodiment values for a digital video signal given in parenthesis):

1. Oversample a digital signal, such that the oversampled data has a number of phases (3) equaling the oversampling factor (3) and each bit of oversampled data belongs to a phase based on its sampling order;

2. Detect logical transitions in the oversampled data;

3. Tally the detected transitions by phase;

4. Select a phase by referencing a phase having the most number of transitions greater than a minimum number (3) for a predetermined number of sets of oversampled data (3). If more than one phase meets this criteria (and one of these phases is the previously selected phase) or no phases meet this criteria then select the previously selected phase. If none of the phases meeting the criteria are the previous phase then select a phase according to a predetermined rule (lower phase index is favored);

5. Output the output phase based on the selected phase.

In practical application, the transition detection logic 34, the tallying logic 36, and the decision logic 38 can be realized with conventional logic gates or state machines arranged to conform to the method of the present invention. The predetermined rule of the decision logic 38 for favoring a particular phase and the minimum number of transitions required by the tallying logic 36 can both be set to give the best results for a given application. Additionally, when selecting a phase that is offset from the transition phase, the number of phases offset can be changed to meet design requirements. Moreover, the order and arrangement of the 30-bit oversampled data can be changed from that described (i.e. changed to S0[0:29]) to minimize the size and cost of the transition counter 32 and the decision logic 38 for a particular application. Finally, the latches 30 and 40 can be increased or decreased in number as necessary to accommodate larger or smaller oversampled data segments, or faster or slower logic of the transition counter 32 and the decision logic 38.

In contrast to the prior art, the present invention identifies and tallies transitions in an oversampled data segment, and selects a phase of the oversampled data having more transitions for a predetermined series of data segments. The data of the phase selected by the present invention method better corresponds to the original data segments sampled particularly in the case of circuit unbalance and skewed original data.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for receiving a digital signal, the digital signal comprising data segments each having a number of bits, the method comprising:
digitally oversampling a data segment of the digital signal by an oversampling factor to generate an oversampled data segment having a number of bits equal to the number of bits of the data segment multiplied by the oversampling factor; wherein each bit of the oversampled data corresponds to a phase that is equal to a sampling order of the bit, and a number of phases is equal to the oversampling factor;
detecting transitions in the oversampled data, a transition being a change from a logical one to a logical zero and from a logical zero to a logical one;
tallying transitions for each phase;
selecting as an output phase a phase that is a fixed number of phases offset from a phase that has the most number of transitions and has more than a predetermined number of transitions for a predetermined number of data segments of the digital signal; and
outputting bits of the oversampled data corresponding to the phase selected as the output phase.

2. The method of claim 1 wherein the predetermined number of transitions is three, the predetermined number of data segments is three, and the three data segments are adjacent.

3. The method of claim 2 wherein the fixed number of phases is one, such that the phase adjacent to and after the phase having more than a predetermined number of transitions for a predetermined number of data segments is selected as the output phase.

4. The method of claim 1 further comprising selecting as an output phase a previous output phase when no phase of the plurality of phases has more than the predetermined number of transitions for the predetermined number of data segments.

5. The method of claim 1 further comprising selecting as an output phase a previous output phase when more than one phase of the plurality of phases have an equal number of transitions being the most number of transitions and being more than the predetermined number of transitions for the predetermined number of data segments and when one of these phases is the previous phase.

6. The method of claim 1 further comprising selecting as an output phase a phase according to a predetermined rule when more than one phase of the plurality of phases has the same most number of transitions and has more than the predetermined number of transitions for the predetermined number of data segments and when none of these phases is a previous output phase.

7. The method of claim 1 wherein detecting transitions in the oversampled data comprises performing an exclusive OR function between adjacent bits of the oversampled data, a last bit being adjacent to a first; wherein a logical one output identifies a transition.

8. The method of claim 1 wherein the digital signal is a digital video signal having a data segment of 10 bits, the oversampling factor and corresponding number of phases is three, and the oversampled data segment has 30 bits.

9. A device for performing the method of claim 1.

10. A circuit for receiving a digital signal, the digital signal comprising data segments each having a number of bits, the circuit comprising:
a phase-locked loop for receiving a clock of the digital signal and for outputting a plurality of clocks;
an oversampler for oversampling bits of the digital signal by an oversampling factor and outputting an oversampled data segment, each bit of the oversampled data corresponding to a phase that is equal to a sampling order of the bit, a number of phases being equal to the oversampling factor;
a skew compensator electrically connected to the oversampler for receiving the oversampled data and determining an output phase, the skew compensator comprising:
a transition counter electrically connected to the oversampler for detecting digital transitions of the oversampled data and tallying each transition according to each phase;
decision logic electrically connected to the transition counter for selecting a phase as the output phase based on the tallied transitions of each phase; and
a phase selector having inputs electrically connected to the oversampler and a setting end electrically connected to the decision logic for selecting and outputting bits of the oversampled data corresponding to the output phase; and
a decoder electrically connected to the phase selector for decoding the bits of the oversampled data;
wherein the oversampler, the skew compensator, and the decoder operate in synchronization according to the plurality of clocks.

11. The circuit of claim 10 wherein the skew compensator further comprises a shift register having an input electrically connected to the oversampler, a first output electrically connected to the transition counter, and a second output electrically connected to the phase selector, wherein the first output is between the input and the second output, the shift register for delaying output of the oversampled data to the phase selector.

12. The circuit of claim 10 wherein the phase selector is a multiplexer.
